(19) United States
(12) Patent Application Publication
(10) Pub. No.: US 2003/0156651 A1
(43) Pub. Date: Aug. 21, 2003

(54) Method for reducing code artifacts in block coded video signals

(76) Inventors: Stephen Bernard Streater, Wimbledon, London (GB); Brian David Brunswick, Wimbledon, London (GB); Richard James Davies, Dulwich, London (GB); Andrew James Stuart Slough, Luton, Bedfordshire (GB); Frank Antoon Vorstenbosch, Wimbledon, London (GB)

Correspondence Address: SUGHRUE MION, PLLC, 2100 PENNSYLVANIA AVENUE, N.W., WASHINGTON, DC, 20037, US

(21) Appl. No.: 10/311,938

(22) PCT Filed: Jul. 5, 2001
(86) PCT No.: PCT/GB01/03031

(30) Foreign Application Priority Data
Jul. 7, 2000 (JP) 0016838.5

(51) Int. Cl. H04N 7/12

(52) U.S. Cl. 375/240.25; 375/240.24

(57) ABSTRACT

Digital data representing individual pixels of a video image frame are read and then encoded as a series of binary coded words describing blocks of pixels typically eight by eight for transmission or storage. When the words are decoded an assessment is made as to when a set of pixels representing a region of the video image frame signifying an object at least overlaps into other blocks. Subregions of the blocks in question which make up the whole region are identified and their pixel luminance and chrominance values and these values are interpolated across the region to smooth out transitions across boundaries artificially delimiting the subregions. A library of masks representing luminance values for all the pixels in a block can be made available in order to enhance the compression process.

This invention relates to a method of processing of digital video information. This digital video information is compressed for storage and then transmission, for example over the internet.

There is a need for highly efficient compression techniques to be developed to enable transmission of video in real time over the internet because of the restrictions in the bandwidth. Typical compression of at least 1,000 times is required to transmit full screen, full motion video over a typical 56 kb/s modem.

An object of the invention is to provide such compression techniques.

### GENERAL BACKGROUND

The video to be compressed can be considered as consisting of a number of frames (at least 1), each made up of individual picture elements, or pixels. Each pixel can be represented by three components, usually either RGB (red, green and blue) or YUV (luminance and two chrominance values). These components can be any number of bits each, but eight bits of each is usually considered sufficient.

The human eye is more sensitive to the location of edges in the Y values of pixels than the location of edges in U and V. For this reason, the preferred implementation here used the YUV representation for pixels.

The image size can vary, with more pixels giving higher resolution and higher quality, but at the cost of higher data rate. Where the source video is in PAL format, the image fields have 288 lines with 25 frames per second. Square pixels give a source image size of 384×288 pixels. The preferred implementation has a resolution of 376×280 pixels using the central pixels of a 384×288 pixel image, in order to remove edge pixels which are prone to noise and which are not nomally displayed on a TV set.

The pixels are hard to compress individually, but there are high correlations between each pixel and its near neighbours. To aid compression, the image is split into rectangular components, called “super-blocks” in this application, which can be thought of as single entities with their own structure. These blocks can be any size, but in the preferred implementation described below, the super-blocks are all the same size and are 8×8 pixel squares.

It is apparent that if each super-block is compressed separately, the errors resulting from the compression process can combine across edges between super-blocks thus illustrating the block-like nature of the compression by highlighting edges between blocks, which is undesirable. It is important that the decompression and/or display process removes as far as possible any visible artefacts across super-block boundaries.

### SUMMARY OF THE INVENTION

According to the invention there is provided a method of processing digital video information in an adapted compressed format for transmission or storage and then decompressing the information in the compressed format to obtain reconstructed digital video information; said method comprising:

reading digital data representing individual picture elements (pixels) of a video image frame as a series of binary coded words;

encoding to derive from the words representing individual pixels further codewords each describing blocks or other groups of pixels and

decoding to derive from the further codewords together with any previously decoded video image frames a series of binary coded words each representing individual pixels of the reconstructed video image frame, characterized in that the decoding operation includes determining when a set of pixels collectively representing a region (Y1, Y2a, Y3a, Y4a) of the original video image frame signifying a discernable object covers completely or overlaps into groups or blocks of pixels encoded by more than one said further codeword, and in such cases:

identifying those subregions (Y1, Y2a, Y3a, Y4a) of each of the groups or blocks which together make up the region;

determining the pixel values, including brightness (luminance), colour (chrominance) or any combination encoded for these subregions in their respective further codewords and

interpolating these pixels values from each subregion across the pixels of the reconstructed video image frame for the region to smooth the transitions across boundaries delimiting the subregions.

The invention also extends separately to a method of encoding pixel values suitable for the aforesaid method of processing as well as a method of decoding such information for display or playback.

The derivation of the further codewords may involve establishing the following data about the group or block:

i) a number of luminance values to represent the luminance values of all the pixels in the group or block and

in the case where there are multiple representative luminances using a mask as a means of indicating which of the representative luminances are to be used in determining the appropriate luminance value of each pixel for the reconstructed video image frame and

ii) a representative chrominance value.

The encoding operation then involves evaluating each of the values i) and ii) for previous groups or blocks in the same video image frame or the same group or block in another frame or frames and comparing values in a predetermined sequential order, to detect differences and hence changes, following which the new value or difference in value is included in the compressed format.

The method may comprise encoding to derive from the words representing individual pixels further words describing blocks or groups of pixels each described as a single derived word which at least includes a representation of the luminance of a block component of at least eight by eight individual pixels (super-block);

establishing a reduced number of possible luminance values for each block of pixels (typically no more than four);

providing a series of changeable stored masks as a means for indicating which of the possible luminance values are to be used in determining the appropriate luminance value of each pixel for display;

comparing and evaluating the words representing corresponding portions of one frame with another frame or frames in a predetermined sequential order of the elements making up the groups to detect differences and hence changes;

identifying any of the masks which require updating to reflect such differences and choosing a fresh mask as the most appropriate to represent such differences and storing the fresh mask or masks for transmission.

Preferably each block of pixels is described as a codeword containing a header, at least one of each of Y, U and V values, an indication (a so-called gap) of the location of the block in relation to a preceding block and the aforesaid mask. The mask of each block effectively subdivides the block into regions where pixels with the same mask value are deemed to be in the same region. It follows that the same mask values in different blocks do not necessarily signify corresponding regions of those blocks. Accordingly, another indication (“joins”) are best included in the block description to indicate regions of the image which overlap neighbouring blocks. The header portion of each codeword defines which of the above components of the block have changed on this frame and is desirably Huffman encoded.

The mask portion of a codeword may represent:

(i) a newly created mask, for example when a complex mask becomes entirely uniform; or

(ii) represent a difference from a previously adopted mask, for example where the changes are minimal.

The mask of type (i) may be chosen from a library of masks including the following:

(a) uniform 0 i.e. the whole mask contains zeros;

(b) uniform 1 i.e. the whole mask contains ones;

(c) straight edge i.e. a straight boundary between two contrasting regions of given inclination to the vertical and given distance from the centre of the block;

(d) interpolated edge i.e. a straight edge which is calculated by interpolation from a given first edge from one frame and a given second edge from a subsequent frame and the position of the relevant block between these two frames;

(e) predictable i.e. using the information from neighbouring blocks alone to ascertain the contents of this block; and

(f) raw i.e. no highly compressed representation is known, and the block is compressed using a fractal technique by subdividing it into four recursively until each subdivision is uniform

The mask of type (ii) may be chosen from a library of masks including the following (where a pixel is considered to be on an edge if it has at least one neighbour which has a different mask entry to its own):

(a) 1 diff along edge i.e. a single pixel has changed and this pixel is on an edge;

(b) 1 diff not along edge i.e. a single pixel has changed and this pixel is not on an edge;

(c) 2 diff sided edge i.e. exactly two pixels have changed and they are both on an edge and they both have the same mask value;

(d) 2 diff non-sided edge i.e. exactly two pixels have changed and they are both on an edge and they both have different mask values;

(e) 2 diff not on an edge i.e. exactly two pixels have changed and they are not both on an edge;

(f) n diff sided edge (n>2) i.e. exactly n pixels have changed and they are all on an edge and they all have the same mask value;

(g) n diff non-sided edge (n>2) i.e. exactly n pixels have changed and they are all on an edge and they all have different mask values;

(h) n diff not on an edge (n>2) i.e. exactly n pixels have changed and they are not all on an edge;

(i) big edge i.e. all pixel changes are on an edge;

(j) big diff sided i.e. all pixel changes are on the same side of an edge;

(k) fractal i.e. no highly compressed representation is known, and the block is compressed using a fractal technique by subdividing it into four recursively until each subdivision is uniform and unset or until we have reached the level of individual pixels in which case the value of each pixel in a 2×2 block is explicitly defined; and

(l) n×n box i.e. all the changed pixels within a block fit inside a square of side n and so the position of the square and its contents are both encoded.

In a general sequence of frames, any given block will change on some frames and not on others. Instead of specifying for each frame which blocks have changed on that frame, it is preferable to adopt a different approach In this different approach for each block the frame it changes on is specified i.e. a temporal gap. This means that a codeword for a given block can be specified as valid for a number of frames and reduces the data rate.

In a typical sequence of frames in a video, portions of the frame representing a region of an object changing rapidly, such as the lips of a speaker, have blocks needing frequent updates. In contrast background regions are relatively static. However the rapidly changing portions may move to a previously static part of the image, and vice versa. To accommodate this in an efficient manner, the temporal gap coding scheme supports two definable states, one of which is optimised for rapid changes in a defined location and the other of which is optimised for infrequent changes in a defined location. The method of the invention then preferably includes the additional step of automatically selecting the appropriate state depending on the nature of changes.

In implementations of the invention there is a need to encode from n pixel sets m pixel subsets which can be subsequently utilised. There is a complication since it is comparatively rare than n choose m is a power of 2. Further in accordance with the invention, codewords of length INT(log2(n choose m)) and 1+INT(log2(n choose m)) are adopted. The choice of the codewords to be adopted is simply to naximise the total number of the shortest codewords available. Mask types are chosen so as to correlate the pixels likely to change and the changes which the mask types can represent which tends to ensure that n is minimised in all cases where there is an appropriate mask type representing the change or the updated mask.

It is generally desirable to adopt a technique to match super-block masks based on neighbouring super-blocks wherever possible in order to form regions which may overlap a super-block boundary or boundaries. The implementation of this technique can be as follows:

i) to match the pixels along any edge of a super-block with the pixels along the adjacent edge of a neighbouring super-block if either the 1s or the 0s of the mask along the edge of one super-block can be translated i.e. transposed spatially by one pixel into a subset of the 0s or 1s respectively of the mask along the edge of the neighbouring super-block; and

ii) the Y values i.e. intensities of regions of the super-blocks (as determined by their respective masks) are within a predetermined threshold of one another. If the uncompressed image data is available, a better result can be obtained on compression by replacing stage ii) with iii) as follows: iii) take the subsets according to stage i) and take the intensity values of the pixels in the uncompressed image across both sides of the edge subset referred to in i), and then if these ranges are within a certain pre-determined threshold of overlapping, take the pixels with mask values the same as the edges which are matched in i) in their respective super-blocks and treat them as part of the same regions.

In general, it is quite effective to calculate each displayed Y value by interpolating the four Y values from the four nearest super-blocks to the pixel using bilinear interpolation. In the case where more than one Y value is described for each super-block, it is also necessary to choose which of the values is to be adopted. Further in accordance with the invention the Y values to be adopted for the interpolation are chosen by establishing which regions match across super-block boundaries and using the Y values from such matching regions. The technique for matching regions across super-block boundaries is as follows:

i) to match the pixels along any edge of a super-block with the pixels along the adjacent edge of a neighbouring super-block if either the 1s or the 0s of the mask along the edge of one super-block can be translated i.e. transposed spatially by one pixel into a subset of the 0s or 1s respectively of the mask along the edge of the neighbouring super-block; and

ii) the Y values i.e. intensities of regions of the super-blocks (as determined by their respective masks) are within a predetermined threshold of one another.

It is desirable to adopt a special anti-aliasing technique on decompression and reproduction of the compressed video data in order to ameliorate the problem of jagged edges along mask boundaries within super-blocks caused by the approximation of the edge positions to the nearest pixel. Such a technique involves:

i) identifying two adjoining pixels on a boundary between contrasting mask values to be anti-aliased;

ii) establishing whether the boundary at these pixel locations is tending to be more nearly vertical or horizontal;

iii) establishing end locations of the horizontal or vertical section of the boundary on which the adjoining pixels lie by tracking the boundary in only a horizontal or vertical direction until the pair of pixels are both on the same side of the boundary (but substituting a location four pixels from the pixel location if this is nearer to the pixel location);

iv) establishing the midpoints of the corresponding end locations in the sense of identifying the points mid way along each pixel where mask values changed during stage iii);

v) for each two adjacent pixels adopting a straight line joining these mid points and any intermediate pixels to give a best estimate of the true position of the boundary to sub-pixel accuracy;

vi) ascertaining for each pixel intersecting such a straight line a value proportionate to the area of the pixel which lies on each side of the line; and

vii) adopting a weighted average of the values of the regions on each side of the boundary utilising as the weighting the proportions established at step vi).

In a practical embodiment described hereinafter the groups of pixels are composed of blocks of eight by eight pixels known as super-blocks.

Each super-block is encoded as containing YUV information of its constituent pixels.

This U and V information is stored at lower spatial resolution than the Y information, in one implementation with only one value of each of U and V for every super-block.

The Y values for each pixel within a single super-block can also be approximated. In many cases, there is only one or part of one object in a super-block. In these cases, a single Y value is often sufficient to approximate the entire super-blocks pixel Y values, particularly when the context of neighbouring super-blocks is used to help reconstruct the image on decompression

In many further cases, there are only two or parts of two objects in a super-block. In these cases, a pair of Y values is often sufficient to approximate the entire super-block's Y values, particularly when the context of neighbouring super-blocks is used to help reconstruct the image on decompression. In the cases where there are two Y values, a mask is used to show which of the two Y values is to be used for each pixel when reconstructing the original super-block. These masks can be compressed in a variety of ways, depending on their content, as it turns out that the distribution of masks is very skewed. In addition, masks often change by small amounts between frames, allowing the differences between masks on different frames to be compressed efficiently.

Improvements to image quality can be obtained by allowing masks with more than two Y values, although this increases the amount of information needed to specify which Y value to use.

In a typical frame sequence, only some of the super-blocks have changed from the previous frame, and many of those which change do so in a predictable way. This means that significant data rate reductions can be obtained by only storing super-blocks which have changed, or which have changed in an unexpected way.

The best way of specifying which super-blocks have changed on any given frame depends on the nature of the video content. For example, where a few frames change, but a lot changes in those frames which do change, the spatial gaps between changing super-blocks is an efficient compression method. This method has been used in previous implementations of codecs. On the other hand, where only a few super-blocks change on each frame, but they are spatially correlated, storing the gaps in time between super-block changes is more efficient. For low data rate applications, this is more efficient and a method for compressing temporal gaps is described here. Each super-block making up the image is made up of a variety of components—for example, the luminance, chrominance, shape of each region within it. Different aspects of the super-block can be encoded in various ways, and each component may or may not change from frame to frame. In practice, the distribution of possible changes on any one frame is very skewed, allowing the possibility of significant compression by using variable length codewords.

The distribution of codewords varies between video sections, and so the optimal codewords to use also varies. It is found beneficial to use newly calculated codewords for each section of video, and these codewords are themselves encoded at the start of each video section.

Embodiments of the invention will now be described by way of example only, with reference to, and as illustrated in the accompanying drawings.

### BRIEF DESCRIPTION OF THE DRAWINGS

FIG. 1 shows a typical image of 376×280 pixels divided into 8×8 pixel super-blocks.

FIG. 2 shows a typical super-block of 8×8 pixels divided into 64 pixels.

FIG. 3 is a flow chart showing how gaps between changing super-blocks are encoded.

FIG. 4 shows examples of super-block mask compression types.

FIG. 5 shows how edges and interpolated edge super-block types are compressed.

FIG. 6 shows how the predictable super-block types are compressed.

FIG. 7 shows how pixels within super-block are interpolated.

FIG. 8 shows how regions between neighbouring super-blocks are matched up.

FIG. 9 shows how anti-aliasing on playback is implemented.

### SPECIFIC DESCRIPTION

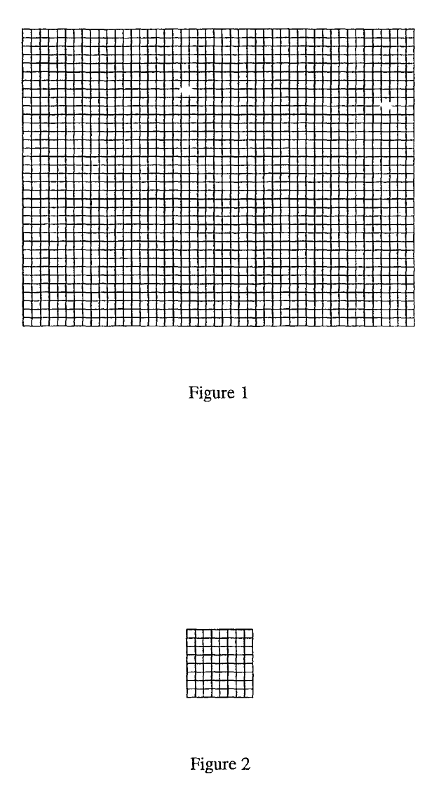

Video frames of typically 384×288, 376×280 or 320×240 pixels (see FIG. 1) are divided into pixel blocks, at least 8×8 pixels in size, called super-blocks (see FIG. 2).

In this implementation, each block contains the following information:

2 Y values (typically 8 bits each)

1 U value (typically 8 bits)

1 V value (typically 8 bits)

64 bits of mask specifying which Y value to use when reconstructing this super-block.

Video Header

Each super-block consists of a codeword specifying which elements of it are updated on the current frame and how these elements are encoded. The most common combinations' codewords are Huffman compressed with the rarer codewords stored as an exception codeword followed by the uncompressed codeword. The Huffman tables are stored at the start of each video or section of video as a header.

Huffman Coding the Super-Block Headers

Each video is split into scenes or sections which can have similar content. The super-block headers are encoded at the start of each of these video sections. The super-block header is typically around 5.5 bits on average.

The information to be contained in the header (before compression) is:

1 bit:

whether Ymax has changed

1 bit:

whether Ymin has changed;

2 bits:

whether UV is unchanged;

whether V is unchanged and U has changed by either ±1;

whether U is unchanged and V has changed by either ±1;

whether UV has changed by (−1,−1), (1,−1), (1,1) or (−1,1) (1+2 bits)

or UV should be resent from scratch as 1+10 bits;

2 bits:

whether to use most recent frame for history

whether to use last but one frame for history

whether to use an older frame for history

1 bit:

whether a small motion vector is used

7 bits:

which mask type to use (see section on mask below)

2 bits:

the way the joins between regions within neighbouring super-blocks

are guessed on playback, with guesses corrected if incorrect:

whether to use the default guess

whether to use the last frame

whether the joins have been resent in their entirety.

Each video section starts with an encoding of the codewords used for the super-block headers in this section. Sort the bits in the header so that the ones which have probability furthest away from 50% of being set are the high bits in the codeword, and the ones which are nearest 50% are the last bits. Where n header bits are used, the ordering of the bits in the Huffman header word is sent as a number which says which of n! possibilities to use.

The codewords are sent in order of length. For each codeword length, the codewords in sorted into numerical order. For each codeword, send a 4 bit number for the number of bits in the difference between the current and the next uncoded header word. The difference starts with a high bit of 1, so don't send this.

Send the remaining bits to make the header word size (for example 14 bits in one current implementation).

Repeat for each codeword length.

It turns out that the frequency distribution of the above codewords differs between frames where there are significant changes (like cuts) and non-cuts. If the headers for these types of frames have their own Huffman codewords, this gives a lower data rate after compression.

Temporal Gaps

Not all super-blocks change on any frame. The best way of specifying which super-blocks have changed on any given frame depends on the nature of the video content. For example, where a few frames change, but a lot changes in those frames which do change, the spatial gaps between changing super-blocks is an efficient compression method. On the other hand, where only a few super-blocks change on each frame, but they are spatially correlated, storing the temporal gaps between super-block changes is more efficient. For low data rate applications, this is more efficient and a method for compressing temporal gaps is described here.

By using temporal gaps, small spatial areas with a lot of changes over time have short codewords for small gaps, and static areas have no impact on the gaps for neighbouring blocks. Super-blocks can be dynamically switched between static and dynamic depending on the distribution of actual gaps over time.

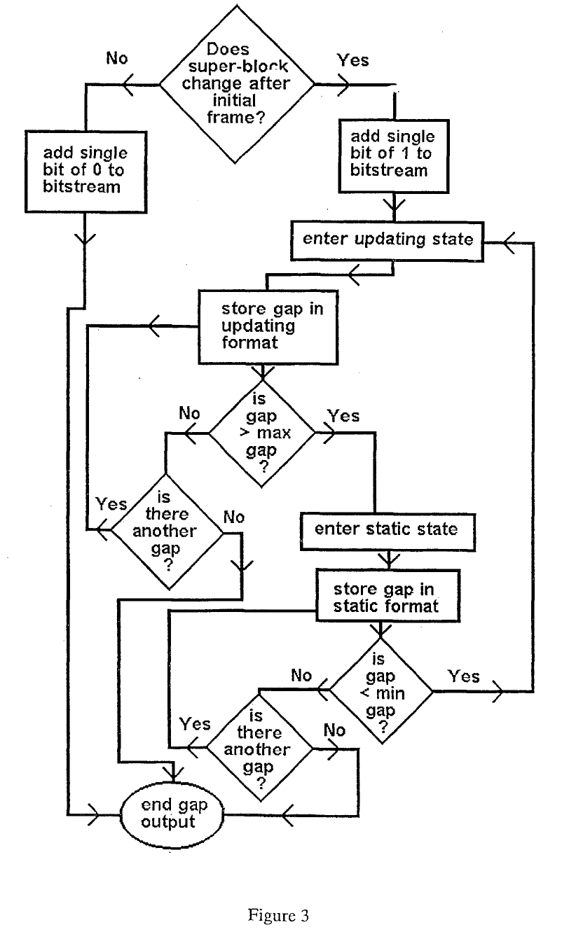

In this implementation (see FIG. 3), a codeword (in one implementation represented by a 1 bit number) at the start of the video section codes whether the super-block is unchanged for the entire video section. In this case, the super-block at this position is never referred to again.

There are two further cases. In the UPDATING case, gaps of 0, 1 and 2 are represented by codewords 0, 01 and 001. Longer gaps are represented by 000 followed by the STATIC gap as follows:

In the STATIC case, gaps of less than 30 are coded as 5 bits, gaps of more than or equal to 30 are encoded as log2(film length) bits and gaps to the end of the film are encoded as 5 bits.

If a gap in the UPDATING case is 8 or more, the state flips to the STATIC case, and if the gap in the STATIC case is less than 5 it flips to the DYNAMIC case.

The exact values for switching cases which minimise the data rate are found to vary slightly depending in the video.

Y

The structure for each super-block is either one region covering the entire super-block with one Y value to base the Y values of the component pixels on, or two sub-regions with different Y values to base the pixel Y component values on. The Y values may change from frame to frame. Either or both of the Y values in a super-block may be combined with context and position information for each pixel within it in order to calculate the correct Y value to use on playback.

Image quality is further enhanced by allowing more than 2 Y values to be used where required.

UV

Each super-block has a U value and a V value. For better quality images, where there are two regions with different Y values, the two regions can be assigned different values of U and V.

Y Mask Compression

A Y mask, which has one entry for each pixel in each super-block, is used to specify which base Y value from this super-block is to be used when calculating the pixel Y value on playback. The Y mask, if non-uniform, divides its super-block into regions. Y, U and V from these regions may be stored with each super-block or calculated using information from pixels outside the super-block.

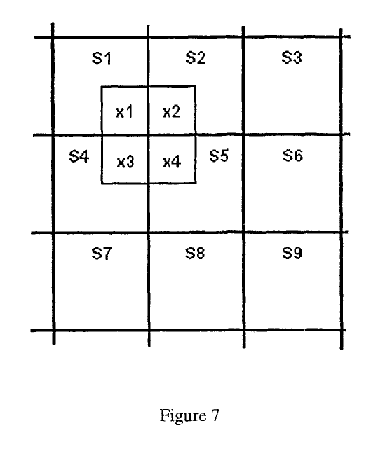

Interpolation between Uniform Super-Blocks

Where uniform super-blocks neighbour each other, bilinear interpolation between the Y, and V values used to represent each block is used to find the Y,U and V values to use for each pixel on playback (see FIG. 7). In this case, the corners of super-blocks S1, S2, S4, and S5 labelled x1, x2, x3 and x4 are calculated from the weighted averages of the Y values for S1, S2, S3 and S4. ps Matching Super Block Masks from Neighbours' Super Blocks

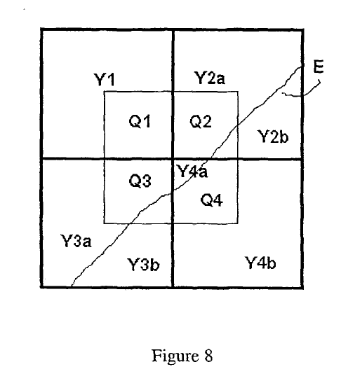

See FIG. 8. Match up any edge which is a subset of another edge on a neighbouring super-block. Match where uniform super-blocks and neighbouring blocks both have eight pixels of one type. The Y values of corresponding super-block regions also have to match up to within a threshold (typically 1/16 of white) in order to treat the regions as being part of the same structure which crosses a super-block boundary. So, in the case of FIG. 8, the subset test would give Y1, Y2a, Y3a and Y4a as candidates for one region, and Y2b, Y3b and Y4b as candidates for a second region. If the Y values within either or both regions were sufficiently close, these would be estimated as part of the same larger region, which crossed super-block boundaries.

Interpolation of Y Values between Non-Uniform Super-Blocks

Where super-block masks indicate more than one region in a super-block, the interpolation should be between only the Y values of matched regions in the nearest four super-blocks to the pixel. (See FIG. 7).

The central values of Ymin and Ymax should correspond in position to the centre of the blocks they are in, or the centre of the pixels of each colour. The centre of each colour may look better but may take longer to play back as the weightings will no longer be in integer multiples of 1/256. Playback speed in Java currently dictates that the faster but less accurate central position is best.

History

Every time a super-block mask changes, the old mask is included in a list of frames which have previously occurred. Every time a mask changes, differences between the new mask and all the previous stored history values are then studied and the most concise difference between the masks is encoded. If this is the shortest possible representation of this super-block mask, it is used in the compressed bitstream.

The actual codeword lengths of the history and the sizes of fixes needed to it are used to find the shortest representation of the new super-blocks.

Reducing the number of likely codewords by having a more constrained model of what super-blocks can be decoded as increases the chances that a perfect match is found in the history.

In one implementation, the history contains the most recent 128 frames.

History works best when it contains not all super-block masks but is arranged with a higher probability of containing more recent frames.

Location

Sometimes, the extra information needed to specify a neighbouring super-block in the history means that it is best to code the differences between the mask and a neighbouring mask at some point in time.

Motion Estimation

Information relating to small motions of each block can be encoded, for example a given history with single pixel motions in any direction This allows masks moving by small distances between frames to be encoded efficiently even when the mask itself and differences in masks between frames are both hard to compress.

In one implementation, single pixel motions in either horizontal or vertical directions, or both together, are encoded in the header for each super-block where motion of the mask is used.

Encodings for Changes to Masks

The data in the mask is split into categories. The coding of each super-block with the lowest data rate is used in each case.

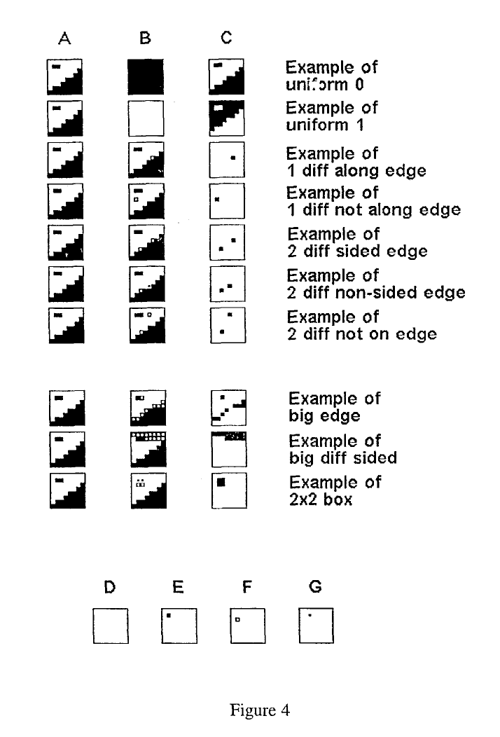

Some of the different types of mask are shown in FIGS. 4, 5 and 6. In FIG. 4, column A shows a possible super-block mask, column B shows a possible updated mask, and column C shows which pixels within the super-block mask have changed between columns A and B, and how they have changed. The key for the changes in column B is shown in columns D-G. Column D shows the representation for unchanged super-block, the black square in column E shows how a set pixel in the mask is represented, column F shows how a pixel which has changed from set to unset is represented and column G shows how a pixel which has changed from unset to set is represented.

Descriptions are given below:

Unchanged

The super-block mask is unchanged from the previous frame. In this case, the header will contain this information and no additional information is given.

Uniform 0

The mask is entirely 0s.

Uniform 1

The mask is entirely 1s.

1 diff along edge

The super-block mask has exactly one pixel changed from the corresponding super-block on the previous frame. This change occurs on an edge, i.e. a pixel which was, on the previous frame, a different mask colour to at least one of its nearest neighbours.

1 diff not along edge

The super-block mask has exactly one pixel changed from the corresponding super-block on the previous frame. This change does not occur on an edge, ie. a pixel which was, on the previous frame, the same colour to all of its nearest neighbours.

2 diff sided edge

The super-block mask has exactly two pixels changed from the corresponding super-block on the previous frame. Both these changes occurs on the same side of an edge, i.e. in both cases a (for example) 0 in the mask is flipped to a 1, or a 1 in the mask is flipped to a 0.

2 diff non-sided edge

The super-block mask has exactly two pixels changed from the corresponding super-block on the previous frame. For example, one pixel is a 0 in the mask is flipped to a 1, and the other is a 1 in the mask is flipped to a 0.

2 diff not on edge

The super-block mask has exactly two pixels changed from the corresponding super-block on the previous frame. The pixels are not both on a edge.

3, 4, . . . diff sided edge

Similar to 2-diff sided edge above, but with the corresponding number of pixels changed.

3, 4, . . . diff non-sided edge

Similar to 2 diff non-sided edge above, but with the corresponding number of pixels changed.

big edge

All the changes between a super-block mask and the corresponding super-block mask from the previous frame are along an edge. Use n choose r coding scheme described below to specify which pixels have changed.

big diff sided

All the changes to the mask are from a first mask colour to a second mask colour, reducing the number of possible codewords needed to describe the changes.

Fractal

Assume that most bits are unset. Send information about which bits are set. If uniform, use ‘0’ Otherwise use 1 and split the 8×8 block into four 4×4 blocks and repeat. Stop at 2×where just use four bits to specify which mask colour to use for each of these four pixels.

n×n box (1<n<8)

All the changed pixels occur with a 2×2 subset of the 8×8 super-block. Send the position of each box within the super-block, the number of changed pixels, and the combination of pixels which have changed.

straight edge

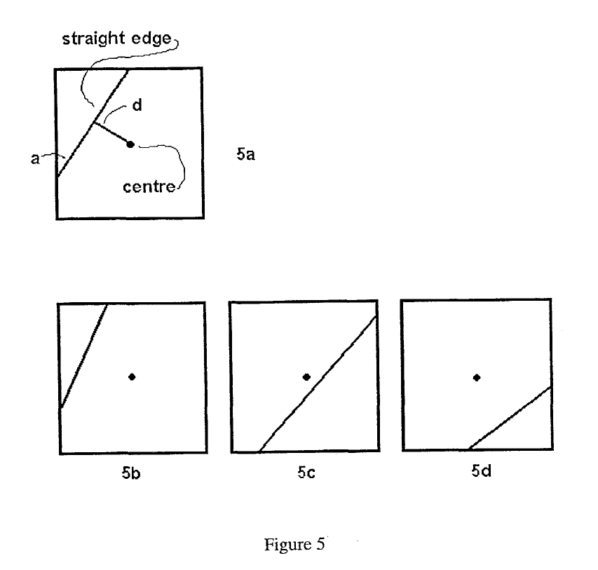

This super-block can be approximated by a straight edge (see FIG. 5a). This is currently represented by a 5 bit angle (a) and a 5 bit closest distance of the edge from the centre (d). In the current representation, both 5 bit values distributed evenly over their possible range. On playback, the edge is converted back into a super-block mask.

interpolated straight edge

A whole sequence of super-blocks can be approximated by interpolating between a first and last masks separated in time (See FIGS. 5b, 5c, 5d). In the case where the first and last frame are both edges, the parameters which define the edges are interpolated between to give the intermediate frames. Diagrams 5b and 5d show the end points of an interpolation, with FIG. 5c showing ann intermediate point in time.

The current implementation allows interpolations of up to 64 frames and gives a codeword length of 26 bits even using a simplistic coding:

represent blocks (where possible) by an edge which has a minimum distance from the centre (coded as 5 bits) and an angle (coded as 5 bits);

work out these parameters at the start and end points of a motion and store a length of interpolation (for example up to 64 frames), and interpolate the parameters linearly between to work out what the mask should look like at any point in time.

Some errors are allowable at any point along the sequence, but all errors have to occur along the edge itself. To allow better consistency with adjoining super-blocks, errors in estimated mask pixels at the edges of the super-block being encoded are treated as more significant than errors not on the edge of the super-block. Overall, the interpolation over the longest time which has an acceptable error rate on every frame is used.

Predictable

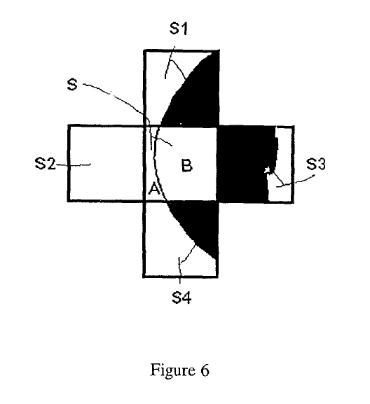

A special 0 bit codeword is used to indicate that a predictable change has taken place. The play-back program then makes the most “obvious” choice as to how to interpret this (see FIG. 6).

In the case where the neighbouring super-blocks run through an edge, this is a Bezier curve chosen to be continuous and smooth at the points where the super-block joins its neighbours. Use the best fit straight line to the known neighbouring super-block edges to find the correct gradient and intersection at each of the two sides of the predictable super-block which the Bezier crosses. The length of the good fit of this line is used as the length of the gradient vector in the Bezier.

This is illustrated in FIG. 6, where the central super-block S is encoded as a 0 bit codeword (although the predictable type is itself encoded in the super-block header and so does take some data). The edges from S1 and S4 are used to predict the edge as it continues through S2 and S3. The intensities of the two regions A and B in S are estimated from the touching regions in the neighbouring super-blocks.

Other cases can be predicted easily as well. In the case where there is just one pixel different from the others, the predictable choice is to have a uniform super-block.

Three Y representations or more can be used in the cases where the edges are surrounded by several other edges.

Raw

Some masks don't fit into any known pattern. In this case, they are just represented as a bit mask compressed using fractal compression similar to above, but with the information about whether each mask bit is set or reset at each scale.

Coding n choose m

Frequently, which one of the possible m pixel subsets out of a set of size n, needs to be coded efficiently. There is little or no internal structure to these choices, and all are approximately equally likely. In these cases n choose m is not typically a power of 2, so coding involves taking codewords of length INT(log2(n choose m)) and 1+INT(log2(n choose m)) so that as many of the shorter codewords as possible are used without causing ambiguity in decoding.

With this method in place, any technique which involves reducing n will reduce the average number of bits needed to encode the m changed pixels. Thus new types of mask which restrict the number of possible pixels changing can be adopted and will result in fewer combinations to choose between and hence lower data rate.

Anti-Aliasing

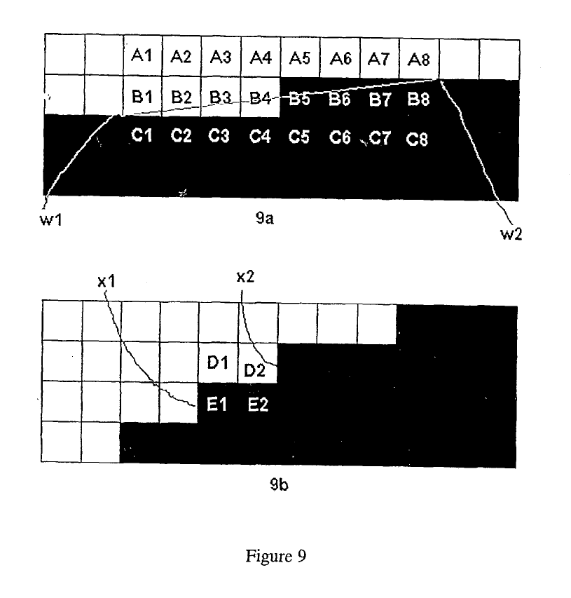

See FIG. 9.

Edges between Y_min and Y_max are currently sharp, showing up individual pixels. There is enough information to allow anti-aliasing along these edges to give effective sub-pixel accuracy.

As discussed previously, the edges between different regions can look quite jagged as only two Y values are used in each sb. If we can work out where the edges are by using context along the edge, we can anti-alias the edges and make them look much more like the original.

For every edge pixel, find out whether the longest horizontal or vertical edge that it is on is horizontal or vertical. Then find the mid points of the ends of this horizontal or vertical section, or a smaller number of pixels if this length exceeds a threshold depending on available processing time (this threshold is currently set to four pixels). Then use a grey scale for this edge pixel which has the Ymin and Ymax values in the ratio of the area of the line joining the midpoints of the ends of the edge and the local Ymin and Ymax values.

In FIG. 9, an edge almost horizontal is shown, and the values A1-A8 will be unchanged by antialiasing, as will the values C1-C8. The values B1-B8 will change linearly from 1/16*A+15/16*B to 15/16*A+1/16*B—i.e. the values which would have been obtained if the edge had run between w1 and w2 and each pixel was shaded by the weighted average of the intensities on each side of the edge.

In FIG. 9, the edge is approximated by joining the points x1 and x2, being the end points of the longest direction along this edge section, giving intensities for E1 and D2 of ¼*D1+¾*E2 and ¾*D1+¼*E1

Thin sticks i.e. one pixel wide, should be left unchanged.

If the edge is convex i.e. the interior edge of a circle, imagine two lines joining the middle of the short edges to the middle of the exterior long edge, and use the areas of these to anti-alias the exterior of the circle. The edge this touches is to be left aliased as it has no protrusions into it.

Leave edges of squares of side two unchanged.

In the case of FIG. 9, an edge is inferred between x1 and x2, and the intensities D2 and E1 are adjusted to be the weighted average of the original Y values of D2 and E2, and E1 and D1 respectively.

1. A method of processing digital video information in an adapted compressed format for transmission or storage and then decompressing the information in the compressed format to obtain reconstructed digital video information; said method comprising:
reading digital data representing individual picture elements (pixels) of a video image frame as a series of binary coded words;
encoding to derive from the words representing individual pixels further codewords each describing blocks or other groups of pixels and
decoding to derive from the further codewords together with any previously decoded video image frames a series of binary coded words each representing individual pixels of the reconstructed video image frame, characterized in that the decoding operation includes determining when a set of pixels collectively representing a region (Y1, Y2a, Y3a, Y4a) of the original video image frame signifying a discernable object covers completely or overlaps into groups or blocks of pixels encoded by more than one said further codeword, and in such cases:
identifying those subregions (Y1, Y2a, Y3a, Y4a) of each of the groups or blocks which together make up the region;
determining the pixel values encoded for these subregions in their respective further codewords and
interpolating these pixels values from each subregion across the pixels of the reconstructed video image frame for the region to smooth the transitions across boundaries delimiting the subregions.

2. A method according to claim 1, wherein the compressed format includes additional join codewords which specify which subregions represent the same region.

3. A method according to claim 2, wherein the decoding operation involves using a pre-determined algorithm for estimating which subregions represent the same region and the encoding operation omits additional join codewords from the compressed format when this algorithm is effective.

4. A method according to claim 1, 2 or 3, wherein the derivation of further codewords involves establishing the following data about the group or block:
i) a number of luminance values to represent the luminance values of all the pixels in the group or block and
in the case where there are multiple representative luminances using a mask as a means of indicating which of the representative luminances are to be used in determining the appropriate luminance value of each pixel for the reconstructed video image frame and
ii) a representative chrominance value.

5. A method according to claim 4, wherein the encoding operation involves evaluating each of the values i) and ii) for previous groups or blocks in the same video image frame or the same group or block in another frame or frames and comparing values in a predetermined sequential order, to detect differences and hence changes, following which the new value or difference in value is included in the compressed format.

6. A method according to claim 4 or 5, wherein the subregions are identified as sets of pixels with the same representative luminance indicated in the mask and two subregions in adjacent groups or blocks are matched into a larger region when:
the pixels in the subregion on one side of the shared edge between the adjacent groups or blocks can be transposed spatially by one pixel into a subset of the pixels in the subregion on the other side of the shared edge; and
the encoded luminance values of the subregions are within a predetermined threshold of one another.

7. A method according to claim 4 or 5, wherein the subregions are identified as sets of pixels with the same representative luminance indicated in the mask and two subregions in adjacent groups or blocks are matched into a larger region when:
the pixels in the subregion on one side of the shared edge between the adjacent groups or blocks can be transposed spatially by one pixel into a subset of the pixels in the subregion on the other side of the shared edge; and
the range of luminance values of those pixels in the original video image frame which lie in the subregion on one side of the shared edge has a predetermined relationship to the range of luminance values of those pixels in the original video image frame which lie in the subregion on the other side of the shared edge.

8. A method according to claim 4 or 5, wherein the further codewords each start with a set of flags indicating for all data about the associated group or block, which values are changed and how the new value or difference in value is encoded, followed by the encoded new values or differences themselves.

9. A method according to claim 8, wherein the set of flags at the start of each further codeword are encoded with variable lengths according to the frequency of that value for the flags.

10. A method according to claim 9, wherein the set of flags are encoded according to frequency independently for groups or blocks on video image frames corresponding to cuts and groups or blocks on other video image frames.

11. A method according to claim 4, wherein the mask portion of at least one further codeword represents a difference from a previously adopted mask, which is chosen from a library of masks (FIG. 4) on the basis that a pixel is considered to be on an edge if it has at least one neighbour which has a different mask entry to its own and the library of masks includes masks with:
i) difference along an edge where a specified number of pixels have changed and they are all on an edge;
ii) difference not along an edge where a specified number of pixels have changed and they are not all on the edge; and/or
iii) sided difference along an edge where a specified number of pixels have changed and they are all on the edge and they all have the same representative luminance value indicated by the mask.

12. A method according to claim 4, wherein the mask portion of a further codeword represents a spatial transposition of a previously adopted mask.

13. A method according to claim 4, wherein the mask portion of a further codeword is chosen from a library of masks (FIG. 5) which includes the following:
i) a straight edge where a straight boundary between two luminance values of given inclination to the vertical and given distance from the centre of the group or block;
ii) an interpolated edge where a straight edge is calculated by interpolation between a given first edge from one frame and a given second edge from a subsequent frame and the position in time of the relevant group or block between these two frames; and/or
iii) a predictable edge where the information from neighbouring groups or blocks alone serve to define the mask.

14. A method according to claim 13, wherein the prediction edge case is establishing by extrapolating curves of the edges in the masks of neighbouring groups or blocks (FIG. 6).

15. A method according to any one or more of the preceding claims, wherein in the case where a group or block is substantially unchanged and constant for a number of successive video image frames then the further codeword includes the number of video image frames (temporal gap) for which that group or block is unchanged.

16. A method according to claim 15 and further comprising adopting different states for temporal gap coding, optimised for difference frequencies of changes in a group or block.

17. A method according to any one or more of the preceding claims and further comprising applying antialiasing boundaries between regions on the reconstructed video image frame.

18. A method according to claim 17, wherein the antialiasing is applied by identifying two adjacent pixels on either side of a boundary between regions;
establishing whether the boundary at this location is more nearly vertical or horizontal;
establishing end locations in both directions of the horizontal or vertical section of the boundary by tracking the boundary in the horizontal or vertical direction until the corresponding pair of pixels are both on the same side of the boundary;
establishing the midpoints of corresponding end locations of the horizontal or vertical section of the boundary;
adopting a straight line joining these midpoints to give a best estimate of true position of the boundary to sub-pixel accuracy;
assigning to pixels on the boundary in the reconstructed video image frame antialiased pixel values between the region pixel values weighted proportionately to the area of the pixel which lies on each side of the estimated straight line boundary.

19. A method according to claim 18 and further comprising the step of tracking the boundary to establish end locations is effected by assuming the end location is no further out than a pre-determined distance and this distance is used if an end location is not found at a nearer point (FIG. 9).
